(19) United States
(12) Patent Application Publication
(10) Pub. No.: US 2015/0338057 A1
(43) Pub. Date: Nov. 26, 2015

(54) SIDE-EMITTING LED LENS, AND BACKLIGHT UNIT AND DISPLAY DEVICE COMPRISING SAME

(71) Applicant: ANYCASTING CO., LTD., Gangseo-gu Seoul (KR)

(72) Inventors: Sungbin KIM, Goyan-si, Gyeonggi-do (KR); Byungwook KIM, Incheon (KR); Moojae LEE, Yangsan-si, Gyeongsangnam-do (KR); Jaeyou JUNG, Gwangju-si, Gyeonggi-do (KR)

(21) Appl. No.: 14/758,805

(22) PCT Filed: Jan. 6, 2014
(86) PCT No.: PCT/KR2014/000110

§ 371 Date: Jul. 1, 2015

(30) Foreign Application Priority Data
Jan. 4, 2013 (KR) 10-2013-0001019
Jan. 6, 2014 (KR) 10-2014-0001558

(51) Int. Cl. F21V 5/04; G02F 1/1335; F21V 13/04

(52) U.S. Cl. CPC F21V 5/046; F21V 13/04; G02F 1/133603; G02F 1/133605; G02F 1/133606; G02F 1/133611; G02F 2001/133607

(57) ABSTRACT

Disclosed is a side-emitting LED lens including: a lower surface including an incident surface with light emitted from the LED chip thereon; an upper surface formed to total-reflect directly incident light among light beams incident on the incident surface; and a side surface for connecting the lower surface and the upper surface and formed to emit directly incident light among light total-reflected by the upper surface and light incident on the incident surface, out of the lens. The upper surface is formed to total-reflect light that is emitted from an end point of a light emitting surface of the LED chip, positioned at the same side as an arbitrary point on the upper surface based on an optical axis of the LED chip, and incident on the arbitrary point on the upper surface, towards the side surface.

### CROSS REFERENCE TO PRIOR APPLICATIONS

This application is a National Stage Application of PCT International Patent Application No. PCT/KR2014/000110 filed Jan. 6, 2014, under 35 U.S.C. §371, which claims priority to Korean Patent Application Nos. 10-2013-0001019 filed Jan. 4, 2013, and 10-2014-0001558 filed Jan. 6, 2014, which are all hereby incorporated by reference in their entirety.

### BACKGROUND

The present invention relates to a side-emitting light emitting diode (LED) lens for emitting light emitted from an LED from a side surface of the lens, and a backlight unit and display device including the same.

In general, a display device used as a monitor of a computer, a television (TV), or the like includes a liquid crystal display (LCD). In this regard, the LCD is not capable of emitting light and thus requires a separate light source.

A plurality of fluorescent lamps such as a cold cathode fluorescent lamp (CCFL) or a plurality of light emitting diodes (LEDs) are used as a light source for an LCD, and the light source is included in a back light unit (BLU) together with a light guide plate, a plurality of optical sheets, a reflector, and so on.

Recently, among these light sources, an LED has attracted attention as a next generation light source due to low power consumption, excellent durability, and low manufacturing costs. However, when an LED is used as a light source, since light has a tendency to be intensively emitted to a narrow region, there is a need to uniformly distribute light to a wide region in order to apply the LED to a surface light source such as a display device.

Accordingly, recently, research has been actively conducted into an LED lens for performing this function. In this regard, “SIDE EMITTING LED LENS” is disclosed as a representative prior art in U.S. Pat. No. 6,679,621.

The side emitting LED lens is a lens for emitting light emitted from an LED from a side surface of the lens and includes a reflective surface for reflecting light that is emitted from the LED and incident on the lens to a side surface of the lens. The reflective surface may be formed by reflective-coating an upper surface or formed to total-reflect the incident light by the upper surface.

However, when the reflective surface is formed by reflective-coating an upper surface, manufacturing costs are increased in that a lens is formed of a transparent material via injection molding and then the upper surface is separately reflective-coated, and when the upper surface is formed to total-reflect incident light without reflective-coating, a significant amount of light is not total-reflected off the upper surface and is emitted upwards through the upper surface.

An object of the present invention devised to solve the problem lies in a side-emitting light emitting diode (LED) lens for minimizing the amount of light emitted upwards through an upper surface rather than being total-reflected at the upper surface even if the upper surface is formed to total reflect light incident thereon without reflection coating when a reflective surface is formed.

The object of the present invention can be achieved by providing a side-emitting light emitting diode (LED) lens for emitting light emitted from an LED chip for emitting light as a flat source towards a side surface, including a lower surface including an incident surface with light emitted from the LED chip thereon, an upper surface formed to total-reflect directly incident light among light beams incident on the incident surface, and a side surface for connecting the lower surface and the upper surface and formed to emit directly incident light among light total-reflected by the upper surface and light incident on the incident surface, out of the lens, wherein the upper surface is formed to total-reflect light that is emitted from an end point of a light emitting surface of the LED chip, positioned at the same side as an arbitrary point on the upper surface based on an optical axis of the LED chip, and incident on the arbitrary point on the upper surface, towards the side surface

In another aspect of the present invention, provided herein is a side-emitting light emitting diode (LED) lens for emitting light emitted from an LED chip for emitting light as a volume source towards a side surface, including a lower surface including an incident surface with light emitted from the LED chip thereon, an upper surface formed to total-reflect directly incident light among light beams incident on the incident surface, and a side surface for connecting the lower surface and the upper surface and formed to emit directly incident light among light total-reflected by the upper surface and light incident on the incident surface, out of the lens, wherein the upper surface is formed to total-reflect light that is emitted from a lower end point of the side surface of the LED chip, positioned at the same side as an arbitrary point on the upper surface based on an optical axis of the LED chip, and incident on the arbitrary point on the upper surface, towards the side surface.

In another aspect of the present invention, provided herein is a back light unit (BLU) using a light emitting diode (LED) chip as a light source, including the aforementioned LED lens on the LED chip.

In another aspect of the present invention, provided herein is a display device using a light emitting diode (LED) chip as a light source, including the aforementioned LED lens on the LED chip.

When a side-emitting LED lens configured above according to the present invention is formed such that an upper surface total-reflects light incident on an inner part of the lens towards a side surface, a light source for light emitted from an LED chip is formed to be considered as a flat source or a volume source instead of one point source, thereby minimizing the amount of light that is emitted upwards through the upper surface.

When the side-emitting LED lens according to the present invention is formed such that an upper surface total-reflects light incident on an inner part of the lens towards a side surface, a shape of an incident surface on which light emitted from the LED chip and incident on the inner part of the lens is considered, thereby minimizing the amount of light emitted upwards through the upper surface.

### BRIEF DESCRIPTION OF THE DRAWINGS

FIG. 1 is a vertical cross-sectional view of a side-emitting light emitting diode (LED) lens according to an embodiment of the present invention.

FIG. 2 is a diagram illustrating a state in which an upper surface of a conventional side-emitting LED lens is formed so as to total-reflects incident light.

FIGS. 3 and 4 are diagrams for explanation of a condition of an upper surface when a light source for light emitted from an LED chip is considered as a flat surface like a lens according to the present invention.

FIG. 5 is a diagram for explanation of a condition of an upper surface in consideration of a shape of an incident surface.

FIG. 6 is a diagram schematically illustrating an LED chip with a light emitting surface on an upper surface, according to an embodiment of the present invention.

FIG. 7 is a schematic diagram of an LED chip as a volume source.

FIG. 8 is a diagram for explanation of a condition of an upper surface when a light source for light emitted from an LED chip is considered as a volume source.

FIGS. 9 and 10 are diagrams for explanation of a condition of a side surface when a light source for light emitted from an LED chip is considered as a flat source.

FIG. 11 is a diagram for explanation of a condition of a side surface when a light source of light emitted from an LED chip is considered as a volume source.

### DETAILED DESCRIPTION

Exemplary embodiments of the present invention are described in detail so as for those of ordinary skill in the art to easily implement with reference to the accompanying drawings.

As the invention allows for various changes and modifications, particular embodiments will be illustrated in the drawings and described in detail in the written description. However, this is not intended to limit the present invention to particular modes of practice, and it is to be appreciated that all changes, equivalents, and substitutes that do not depart from the spirit and technical scope of the present invention are encompassed in the present invention.

For clarity, thicknesses and sizes of components are exaggerated in the drawings, and accordingly the present invention is not limited by relative thicknesses and sizes illustrated in the accompanying drawings.

The present invention relates to a side-emitting light emitting diode (LED) lens for minimizing the amount of light emitted upwards through an upper surface rather than being total-reflected at the upper surface even if the upper surface is formed to total reflect light incident thereon without reflection coating when a reflective surface for emitting light emitted from an LED chip towards a side surface is formed. In addition, the present invention also relates to a back light unit (BLU) and a display device, including the LED lens. However, other configurations of the BLU and display device except for the LED lens may be easily implemented by one of ordinary skill in the art, and thus a detailed description thereof will be omitted in the specification.

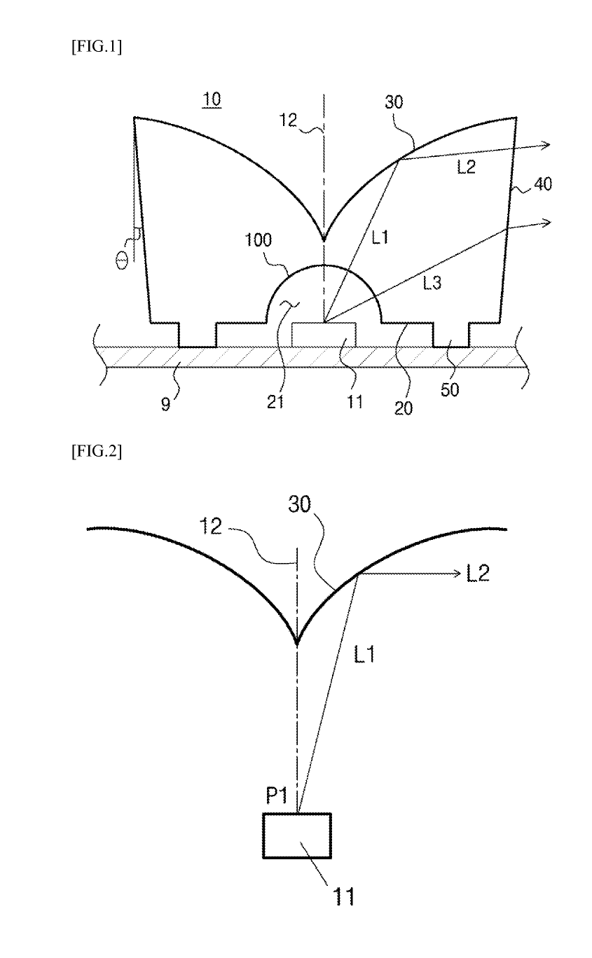

FIG. 1 is a vertical cross-sectional view of a side-emitting light emitting diode (LED) lens 10 according to an embodiment of the present invention.

Referring to FIG. 1, the side-emitting LED lens 10 according to an embodiment of the present invention includes a lower surface 20, an upper surface 30, and a side surface 40 that connects the lower surface 20 and the upper surface 30.

The lower surface 20 may include an incident surface 100 on which light emitted from an LED chip 11 installed on a circuit board 9 is incident, and the incident surface 100 may be formed as an internal surface of a groove portion 21 formed in a central portion of the lower surface 20. As such, as illustrated in FIG. 1, the incident surface 100 formed as the internal surface of the groove portion 21 may have an approximate circular shape such that light emitted from the LED chip 11 is incident on an inner part of the lens 10 without refraction, but embodiments of the present invention is not limited thereto. For example, the incident surface 100 may have various shapes such that light emitted from the LED chip 11 is refracted and incident on an inner part of the lens 10.

The upper surface 30 is formed so as to total-reflect light L1 incident directly on the upper surface 30 among light beams that are emitted from the LED chip 11 and incident on an inner part of the lens 10 through the incident surface 100 towards the side surface 40, and the side surface 40 is formed so as to emit light L2 total-reflected from the upper surface 30 out of the lens 10. In particular, the side surface 40 is formed so as to emit light L3 incident directly on the side surface 40 among light beams, which are emitted from the LED chip 11 and incident on an inner part of the lens 10 through the incident surface 100, out of the lens 10, which will be described in detail.

In addition, the side surface 40 may be increasingly inclined upwards by a predetermined angle θ based on an optical axis 12 or increasingly inclined downwards by the predetermined angle θ based on the optical axis 12. For example, as illustrated in FIG. 1, the side surface 40 may include an inclination surface that is expanded upwards by the predetermined angle θ based on the optical axis 12. Although not illustrated, the side surface 40 may have a shape curved downwards, include an inclination surface that is expanded downwards by a predetermined angle based on the optical axis 12, or have a shape curved upwards. That is, the side surface 40 may be expanded in any one direction of upwards or downwards directions based on the optical axis 12, and thus when the lens 10 is manufactured via injection molding, a lower mold may be easily separated so as to easily manufacture the lens 10.

In general, an LED lens may be formed of a transparent material with excellent transmittance such as glass, methylmethacrylate, polymethylmethacrylate (PMMA), polycarbonate (PC), and poly ethylen terephthalate (PET) and manufactured as one body via injection molding. In this regard, although a plurality of molds is required to manufacture a lens via injection molding, the lens 10 according to the present invention is configured in such a way that the side surface 40 is expanded in one direction of upwards or downwards directions based on the optical axis 12, and thus injection molding may be possible by only two molds such as a lower mold and an upper mold, and the upper mold and the lower mold may be easily separated upwards and downwards, respectively.

In addition, the lens 10 according to the present invention may further include a leg 50 that extends downwards from a predetermined position of the lower surface 20 and is coupled onto the circuit board 9 to support the lens 10.

As described above, the upper surface 30 may be formed to total-reflect the directly incident light L1 among light beams that are emitted from the LED chip 11 and incident on the incident surface 100 towards the side surface 40 and will be described in detail.

FIG. 2 is a diagram illustrating a state in which an upper surface of a conventional side-emitting LED lens 1 is formed so as to total-reflects incident light.

As illustrated in FIG. 2, the conventional side-emitting LED lens 1 is formed such that the upper surface 30 total-reflects directly incident light L1 towards the side surface 40. In this regard, the conventional side-emitting LED lens 1 is formed to total-reflect only light emitted from one point source, that is, a first reference point P1 as an intersection point between the LED chip 11 and the optical axis 12, among light beams emitted from the LED chip 11.

However, since the side-emitting LED lens 10 according to the present invention is not formed with a much greater volume than the LED chip 11, when the side-emitting LED lens 10 is formed in such a way that the upper surface 30 total-reflects only light emitted from the first reference point P1 assuming that light emitted from the LED chip 11 is one point source like a conventional lens, a significant amount of light is accordingly emitted upwards through the upper surface 30 rather than being total-reflected off the upper surface 30.

Accordingly, when the side-emitting LED lens 10 according to the present invention is formed such that the upper surface 30 total-reflects directly incident light L1, a light source for light emitted from the LED chip 11 may be formed to be considered as a flat source or a volume source instead of one point source, thereby minimizing the amount of light that is emitted upwards through the upper surface 30 rather being total-reflected off the upper surface 30. Here, whether a light source for the light emitted from the LED chip 11 is considered as a flat source or a volume source may be determined according to a shape of the LED chip 11, which will be described below.

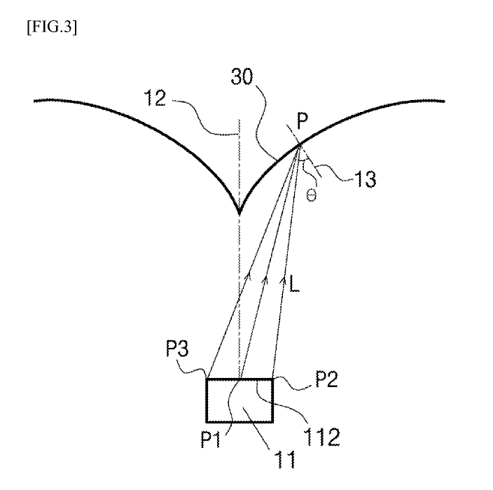

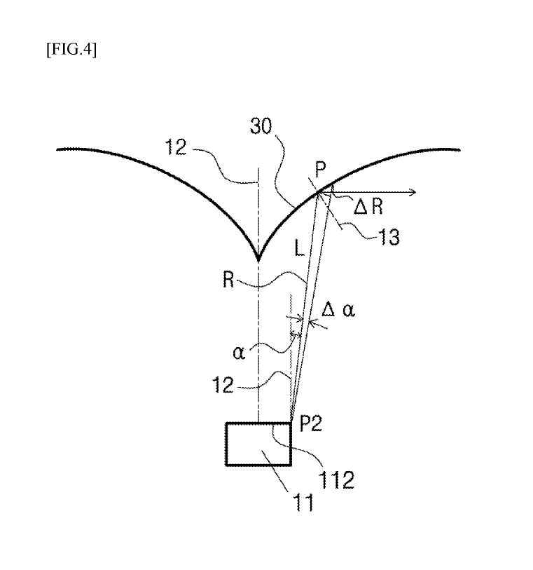

FIGS. 3 and 4 are diagrams for explanation of a condition of an upper surface when the light source for light emitted from an LED chip is considered as a flat surface like a lens according to the present invention.

Referring to FIG. 3, when a light source of the LED chip 11 is considered as a flat source instead of one point source, light emitted from opposite end points P2 and P3 of a light emitting surface 112 of the LED chip 11 as well as light emitted from a central point of the LED chip 11, that is, the first reference point P1 needs to be considered. In this case, it may be known that an angle θ between a normal 13 at an arbitrary point P on the upper surface 30 and light L that is emitted from an end point P2 of the light emitting surface 112, positioned at the same side as the arbitrary point P based on the optical axis 12, and incident on the arbitrary point P is smaller than in the case in which light is emitted from an end point P3 positioned at a different side from the first reference point P1 and incident on the first reference point P1. Accordingly, when the upper surface 30 is formed so as to total-reflect the light L that is emitted from the end point P2 of the light emitting surface 112 at the same side as the arbitrary point P and incident on the arbitrary point P, the upper surface 30 may total-reflect almost all light beams that are emitted from the light emitting surface 112 of the LED chip 11 and are incident directly on the upper surface 30, thereby minimizing the amount of light emitted upwards through the upper surface 30.

A condition of the upper surface 30 will now be described with reference to FIG. 4. When the end point P2 of the light emitting surface 112 of the LED chip 11, positioned at the same side as the arbitrary point P on the upper surface 30, is determined as a second reference point P2, if an angle between the optical axis 12 and the light L that is emitted from the second reference point P2 and reaches the arbitrary point P is α, a distance between the second reference point P2 and the arbitrary point P on the upper surface 30 is R, increment in α is Δα, increment in R with respect to Δα is ΔR, and a refractive index of a material for forming the lens 10 is n, the upper surface 30 may be configured to satisfy a condition ΔR/(RΔα) [symbol] 1/√(n²−1) (hereinafter, referred to as ‘condition 1’).

That is,

ΔR/(RΔα) [symbol] 1/√(n²−1) condition 1:

(Here, α: angle between the optical axis 12 and the light L that is emitted from the second reference point P2 and reaches the arbitrary point P, Δα: increment in α, R: distance between the second reference point P2 and the arbitrary point P on the upper surface 30, ΔR: increment in R with respect to Δα, and n: refractive index of a material for forming the lens 10)

As described above, when the upper surface 30 is configured to satisfy the condition 1, almost all light beams that are emitted from the light emitting surface 112 of the LED chip 11 and incident directly on an inner part of the lens 10 through the incident surface 100 may be total-reflected towards the side surface 40, thereby minimizing the amount of light emitted upwards through the upper surface 30.

The condition 1 is satisfied when a shape of the incident surface 100 is not considered. In reality, since the light emitted from the LED chip 11 is refracted according to the shape of the incident surface 100 and incident on the inner part of the lens 10, the upper surface 30 may be formed in consideration of the shape of the incident surface 100 in order to minimize the amount of light emitted upward rather than being total-reflected off the upper surface 30. To this end, the condition 1 needs to be defined with respect to an angle between the optical axis 12 and light L′ obtained by refracting the light L by the incident surface 100 instead of the L that is emitted from the second reference point P2 and reaches the arbitrary point P on the upper surface 30.

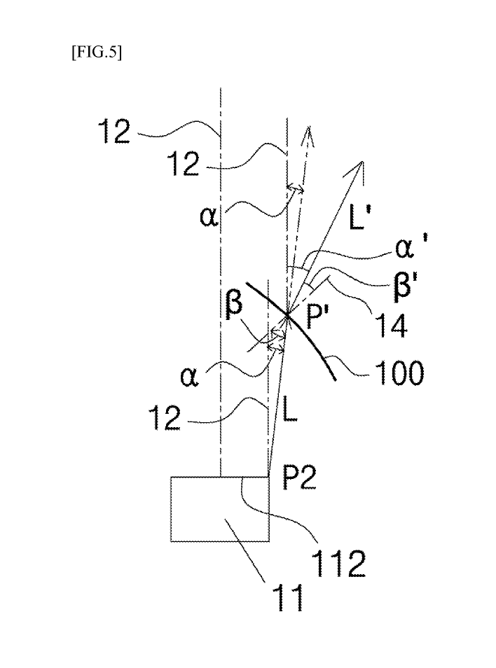

FIG. 5 is a diagram for explanation of a condition of an upper surface in consideration of a shape of an incident surface.

Referring to FIG. 5, when an angle between the optical axis 12 and light L emitted from the second reference point P2 is α, an angle between the optical axis 12 and light L′ obtained by refracting the light L by the incident surface 100 is α′, an angle between the light L emitted from the second reference point P2 and a normal 14 at an arbitrary point P′ on the incident surface 100 is β, and an angle between the normal 14 between the refracted light L′ is β′, the following equations are satisfied.

Sin β=n×Sin β′

α′=α+β−β′=α+β−sin⁻¹((1/n)×sin β)

Accordingly, the condition (hereinafter, referred to as ‘condition 2’) of the upper surface 30 in consideration of the shape of the incident surface 100 may be defined as follows.

ΔR′/(R′Δα′) [symbol] 1/√(n²−1) Condition 2:

α′=α+β−β′=α+β−sin⁻¹((1/n)×sin β)

(Here, α: angle between the optical axis 12 and light L that is emitted from the second reference point P2 and reaches the arbitrary point P on the incident surface 100, β: angle between the light L emitted from the second reference point P2 and a normal 14 at the arbitrary point P′ on the incident surface 100, α′: angle between the optical axis 12 and light L′ obtained via a process in which the light L reaching the arbitrary point P′ on the incident surface 100 is refracted and reaches the arbitrary point P on the upper surface 30, Δα′: increment in α′, R: distance between the arbitrary point P on the upper surface 30 and the arbitrary point P′ on the incident surface 100, ΔR′: increment in R′ with respect to Δα′, and n: refractive index of a material for forming the lens 10)

Although FIG. 5 illustrates opposite end points of an upper surface of the LED chip 11 as the opposite end points P2 and P3 of the light emitting surface 112, this is schematically illustrated for convenience of description, and embodiments of the present invention are not limited thereto.

Hereinafter, the LED chip 11 will be described in detail according to various embodiments of the present invention.

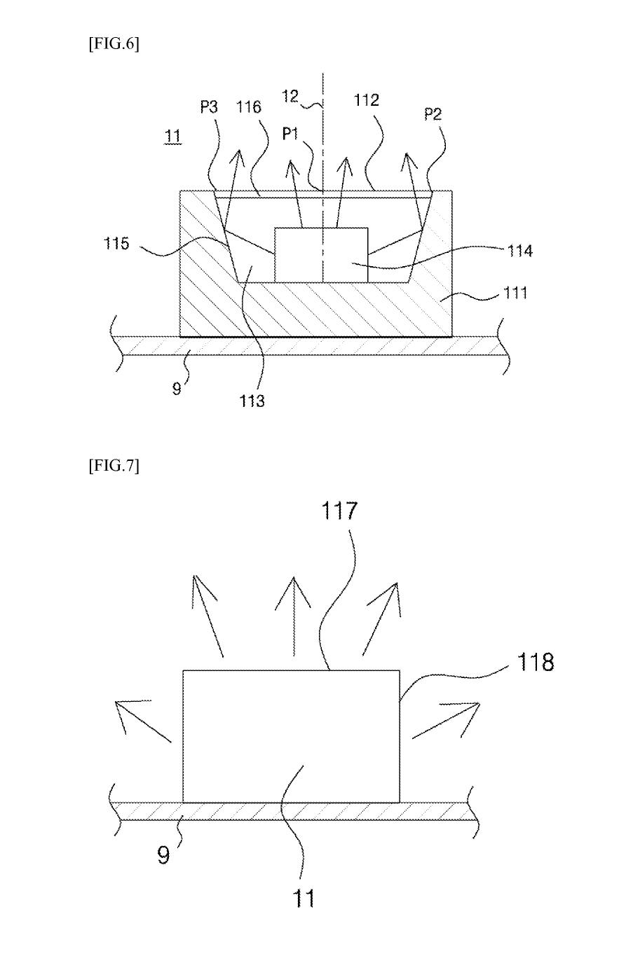

FIG. 6 is a diagram schematically illustrating the LED chip 11 with the light emitting surface 112 on an upper surface, according to an embodiment of the present invention.

Referring to FIG. 6, a configuration of the LED chip 11 as a flat source may include a case 111, a light emitting portion 114 accommodated in a groove 113 formed in the case 111 and emitting light, a reflective surface 115 formed on a side surface of the groove 113 and reflecting light emitted from the light emitting portion 114 upwards, and a transparent plate 116 covering the groove 113.

In the case of the LED chip 11 with this configuration, light that is emitted directly from the light emitting portion 114 and light reflected from the reflective surface 113 are emitted from the LED chip 11 through the transparent plate 116, and thus the LED chip 11 emits light through a flat source, and in this case, the light emitting surface 112 of the LED chip 11 corresponds to an upper surface of the transparent plate 116. However, the LED chip 11 as the flat source may be configured with various shapes and embodiments of the present invention are not limited thereto.

Although the LED chip 11 emits light in the form of the flat source as described above, the LED chip 11 may be configured with a volume source. The LED chip 11 as the volume source is schematically illustrated in FIG. 7.

As illustrated in FIG. 7, when the LED chip 11 emits light in the form of a volume source, light emitted from a side surface 118 as well as from an upper surface 117 of the LED chip 11 unlike the LED chip 11 of the flat source is considered, thereby minimizing the amount of light emitted in an upward direction of the lens 10 through the upper surface 30.

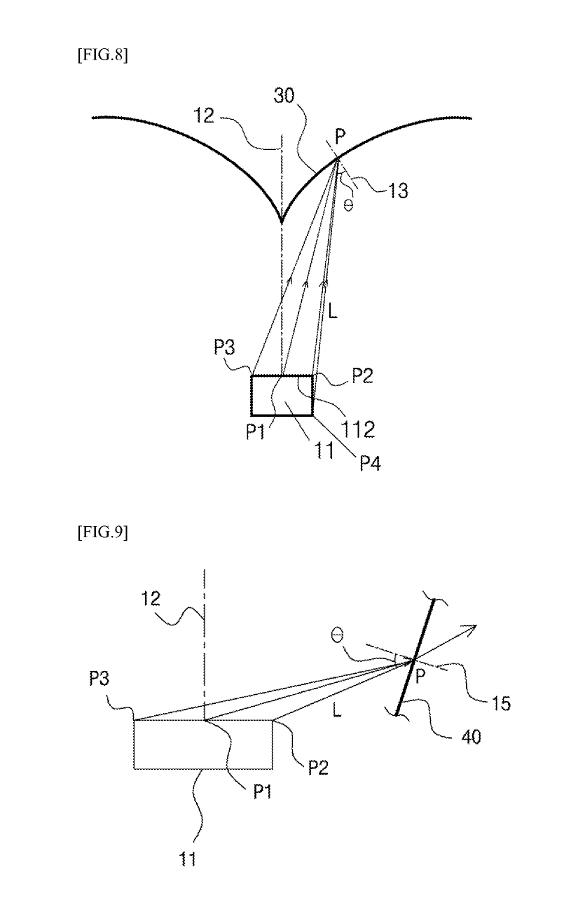

FIG. 8 is a diagram for explanation of a condition of an upper surface when a light source for light emitted from the LED chip 11 is considered as a volume source.

Referring to FIG. 8, when the light source of the LED chip 11 is considered as a volume source, light emitted from the side surface 118 of the LED chip 11 as well as light emitted from the upper surface 117 of the LED chip 11 needs to be considered. In this case, it may be seen that an angle θ between the normal 13 at the arbitrary point P and the light L that is emitted from a lower end portion P4 of the side surface 118 of the LED chip 11, positioned at the same side as the arbitrary point P on the upper surface 30 based on the optical axis 12, and incident on the arbitrary point P is smaller than in the case in which light is emitted from the first reference point P1 and opposite end points P2 and P3 on the upper surface 117 and is incident on the arbitrary point P. Accordingly, when the upper surface 30 is formed so as to total-reflect the light L that is emitted from the lower end portion P4 of the side surface 118 of the LED chip 11 at the same as the arbitrary point P and incident on the arbitrary point P, the upper surface 30 may total-reflect almost all light beams that are emitted in three dimensions from the LED chip 11 as a volume source and are incident directly on the upper surface 30, thereby minimizing the amount of light emitted upwards through the upper surface 30.

A condition (hereinafter, referred to as a ‘condition 3’) of the upper surface 30.

ΔR/(RΔα) [symbol] 1/√(n²−1) Condition 3:

(Here, α: angle between the optical axis 12 and light that is emitted from a fourth reference point P4 and reaches the arbitrary point P when the lower end portion P4 of the side surface 118 of the LED chip 11, positioned at the same side as the arbitrary point P on the upper surface 30 based on the optical axis 12, is considered as the fourth reference point P4, Δα: increment in α, R: distance between the fourth reference point P2 and the arbitrary point P on the upper surface 30, ΔR: increment in R with respect to Δα, and n: refractive index of a material for forming the lens 10)

As described above, in this case, a condition (hereinafter, referred to as a ‘condition 4’) of the upper surface 30 in consideration of the shape of the incident surface 100 may be defined as follows.

ΔR′/(R′Δα′) [symbol] 1/√(n²−1) Condition 4:

α′=α+β−β′=α+β−sin⁻¹((1/n)×sin β)

(Here, α: angle between the optical axis 12 and light L emitted from the reference point P4 and reaches an arbitrary point P′ on the incident surface 100 when the lower end portion P4 of the side surface 118 of the LED chip 11, positioned at the same side as the arbitrary point P on the upper surface 30 based on the optical axis 12, is considered as the fourth reference point P4, β: angle between the normal 14 at the arbitrary point P′ on the incident surface 100 and light L that is emitted from the fourth reference point P4 and reaches the arbitrary point P′ on the incident surface 100, α′: angle between the optical axis 12 and light L′ obtained via a process in which the light L reaching the arbitrary point P′ on the incident surface 100 is refracted and reaches the arbitrary point P on the upper surface 30, Δα′: increment in α′, R: distance between the arbitrary point P on the upper surface 30 and the arbitrary point P′ on the incident surface 100, ΔR′: increment in R′ with respect to Δα′, and n: refractive index of a material for forming the lens 10)

The side surface 40 is formed to emit light L3 as to emit light L3 incident directly on the side surface 40 among light beams, which are emitted from the LED chip 11 and incident on an inner part of the lens 10 through the incident surface 100, out of the lens 10. Like the upper surface 30, when the side-emitting LED lens 10 according to the present invention is formed such that the side surface 40 emits the light L3 incident directly thereon out of the lens 10, a light source for light emitted from the LED chip 11 may be formed to be considered as a flat source or a volume source instead of one point source, thereby minimizing the amount of light that is not emitted out of the lens 10 due to internal total-reflection on the side surface 40.

Hereinafter, the condition of the side surface 40 will be described in detail with reference to the drawings.

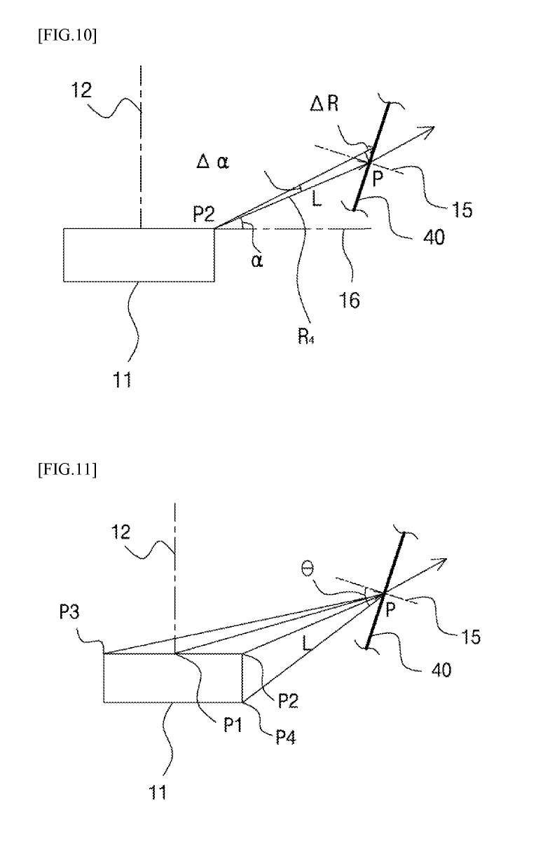

FIGS. 9 and 10 are diagrams for explanation of the condition of the side surface 40 when a light source for light emitted from the LED chip 11 is considered as a flat source like in a lens according to the present invention.

Referring to FIG. 9, when a light source of the LED chip 11 is considered as a flat source, light emitted from the opposite end points P2 and P3 of the light emitting surface 112 of the LED chip 11 as well as light emitted from a central point of the LED chip 11, that is, the first reference point P1 needs to be considered. In this case, it may be seen that an angle θ between a normal 15 at the arbitrary point P and light L6 that is emitted from the end point P2 of the light emitting surface 112, positioned at the same side as the arbitrary point P on the side surface 40 based on the optical axis 12, and incident on the arbitrary point P is much greater than in the case in which light is emitted from an opposite end point P3 to the first reference point P1 and incident on the arbitrary point P. Accordingly, when the side surface 40 is formed so as to emit light L that is emitted from the end point P2 of the light emitting surface 112 at the same side as the arbitrary point P out of the lens 10, even if the light source of the LED chip 11 is considered as a flat source, the side surface 40 may emit almost all light beams that are emitted from the LED chip 11 and incident directly on the side surface 40, out of the lens 10.

The condition of the side surface 40 will now be described with reference to FIG. 10. When the end point P2 of the light emitting surface 112, positioned at the same position as the arbitrary point P on the side surface 40 based on the optical axis 12, is determined as the second reference point P2, if an angle of the optical axis 12 and light L that is emitted from the second reference point P2 and reaches the arbitrary point P on the side surface 40 is α, a distance between the second reference point P2 and the arbitrary point P on the side surface 40 is R, increment in a is Δα, increment in R with respect to Δα is ΔR, and a refractive index of a material for forming the lens 10 is n, the side surface 40 may be configured to satisfy a condition ΔR/(RΔα) [symbol] 1/≈(n2−1) (hereinafter, referred to as a ‘condition 5’).

That is,

ΔR/(RΔα) [symbol] 1/√(n²−1) condition 5:

(Here, α: angle between a horizontal axis 16 perpendicular to the optical axis 12 and light L that is emitted from the second reference point P and reaches the arbitrary point P on the side surface 40, Δα: increment in α, R: distance between the second reference point P2 and the arbitrary point P on the side surface 40, ΔR: increment in R with respect to Δα, and n: refractive index of a material for forming the lens 10)

As described above, when the side surface 40 is configured to satisfy the condition 5, almost all light beams directly incident on the side surface 40 among light beams that are emitted from the light emitting surface 112 of the LED chip 11 and incident on an inner part of the lens 10 through the incident surface 100 may be emitted out of the lens 10, thereby minimizing the amount of light that is internally total-reflected by the side surface 40.

In addition, in this case, a condition (hereinafter, referred to as a ‘condition 6’) of the side surface 40 in consideration of the shape of the incident surface 100 may be defined as follows.

ΔR′/(R′Δα′) [symbol] 1/√(n²−1) Condition 6:

α′=α+β−β′=α+β−sin⁻¹((1/n)×sin β)

(Here, α: angle between the horizontal axis 16 perpendicular to the optical axis 12 and light L that is emitted from the second reference point P2 and reaches the arbitrary point P′ on the incident surface 100, β: angle between the normal 14 at the arbitrary point P′ on the incident surface 100 and the light L that is emitted from the second reference point P2 and reaches the arbitrary point P′ on the incident surface 100, α′: angle between the horizontal axis 16 perpendicular to the optical axis 12 and light L′ obtained via a process in which the light L reaching the arbitrary point P′ on the incident surface 100 is refracted and reaches the arbitrary point P on the upper surface 30, Δα′: increment in α′, R: distance between the arbitrary point P on the side surface 40 and the arbitrary point P′ on the incident surface 100, ΔR′: increment in R′ with respect to Δα′, and n: refractive index of a material for forming the lens 10)

FIG. 11 is a diagram for explanation of a condition of the side surface 40 when a light source of light emitted from the LED chip 11 is considered as a volume source.

Referring to FIG. 11, when a light source of the LED chip 11 is considered as a volume source, light emitted from the side surface 118 of the LED chip 11 as well as light emitted from the upper surface 117 of the LED chip 11 needs to be considered. In this case, it may be seen that an angle θ between the normal 15 at the arbitrary point P and light L that is emitted from the lower end portion P4 of the side surface 118 of the LED chip 11, positioned at the same side as the arbitrary point P on the side surface 40 based on the optical axis 12, and incident on the arbitrary point P is greater than in the case in which light is emitted from the first reference point P1 and the opposite end points P2 and P3 on the upper surface 117 of the LED chip 11 and incident on the arbitrary point P. Accordingly, when the side surface 40 is formed so as to emit light L that is emitted from the lower end portion P4 of the side surface 118 of the LED chip 11 at the same side as the arbitrary point P out of the lens 10, the side surface 40 may emit almost all light beams that are emitted in three dimensions from the LED chip 11 as a volume source and are incident directly on the side surface 40, out of the lens 10, thereby minimizing the amount of light that is internally total-reflected by the side surface 40.

A condition (hereinafter, referred to as a ‘condition 7’) of the side surface 40 may be defined as follows.

ΔR/(RΔα) [symbol] 1/√(n²−1) Condition 7:

(Here, α: angle between the horizontal axis 16 perpendicular to the optical axis 12 and light L that is emitted from the fourth reference P4 and reaches the arbitrary point P on the side surface 40 when the lower end portion P4 of the side surface 118 of the LED chip 11, positioned at the same side as the arbitrary point P on the side surface 40 based on the optical axis 12, is determined as the fourth reference point P4, Δα: increment in α, R: distance between the fourth reference point and the arbitrary point P on the side surface 40, ΔR: increment in R with respect to Δα, and n: refractive index of a material for forming the lens 10)

As described above, when the side surface 40 is configured to satisfy the condition 7, almost all light beams directly incident on the side surface 40 among light beams that are emitted from the LED chip 11 as a volume source and incident on an inner part of the lens 10 through the incident surface 100 may be emitted out of the lens 10, thereby minimizing the amount of light that is internally total-reflected by the side surface 40.

In addition, in this case, a condition (hereinafter, referred to as a ‘condition 8’) of the side surface 40 in consideration of the shape of the incident surface 100 may be defined as follows.

ΔR′/(R′Δα′) [symbol] 1/√(n²−1) Condition 8:

α′=α+β−β′=α+β−sin⁻¹((1/n)×sin β)

(Here, α: angle between the horizontal axis 16 perpendicular to the optical axis 12 and light L that is emitted from the fourth reference point P4 and reaches the arbitrary point P′ on the incident surface 100 when the lower end portion P4 of the side surface 118 of the LED chip 11, positioned at the same side as the arbitrary point P on the side surface 40 based on the optical axis 12, is determined as the fourth reference point P4, β: angle between the normal 14 at the arbitrary point P′ on the incident surface 100 and light L that is emitted from the fourth reference point P4 and reaches the arbitrary point P′ on the incident surface 100, α′: angle between the horizontal axis 16 perpendicular to the optical axis 12 and light L′ obtained via a process in which the light L reaching the arbitrary point P′ on the incident surface 100 is refracted and reaches the arbitrary point P on the side surface 40, Δα′: increment in α′, R: distance between the arbitrary point P on the side surface 40 and the arbitrary point P′ on the incident surface 100, ΔR′: increment in R′ with respect to Δα′, and n: refractive index of a material for forming the lens 10)

As described above, the present invention relates to a side-emitting LED lens for minimizing the amount of light emitted upwards through an upper surface rather than being total-reflected at the upper surface even if the upper surface is formed to total reflect light incident thereon without reflection coating when a reflective surface for emitting light emitted from an LED chip towards a side surface is formed. The embodiments of the present invention may be changed in various ways. Accordingly, the present invention is not limited to the described embodiments and any changeable forms by one of ordinary skill in the art may be within the scope of the present invention.

1. A side-emitting light emitting diode (LED) lens for emitting light emitted from an LED chip for emitting light as a flat source towards a side surface, comprising:
a lower surface comprising an incident surface with light emitted from the LED chip thereon;
an upper surface formed to total-reflect directly incident light among light beams incident on the incident surface; and
a side surface for connecting the lower surface and the upper surface and formed to emit directly incident light among light total-reflected by the upper surface and light incident on the incident surface, out of the lens,
wherein the upper surface is formed to total-reflect light that is emitted from an end point of a light emitting surface of the LED chip, positioned at the same side as an arbitrary point on the upper surface based on an optical axis of the LED chip, and incident on the arbitrary point on the upper surface, towards the side surface.

2. The side-emitting LED lens according to claim 1, wherein the upper surface is formed to satisfy the following condition,
ΔR′/(R′Δα′) [symbol] 1/√(n²−1) condition:
α′=α+β−β′=α+β−sin⁻¹((1/n)×sin β)
(Here, α: angle between the optical axis and light that is emitted from an end point of the light emitting surface of the LED chip and reaches an arbitrary point on the incident surface, β: angle between a normal at the arbitrary point on the incident surface and light that is emitted from the light emitting surface of the LED chip and reaches the arbitrary point on the incident surface, α′: angle between the optical axis and light obtained via a process in which light reaching the arbitrary point on the incident surface is refracted and reaches the arbitrary point on the upper surface, Δα′: increment in α′, R: distance between the arbitrary point on the upper surface and the arbitrary point on the incident surface, ΔR′: increment in R′ with respect to Δα′, and n: refractive index of a material for forming the lens).

3. The side-emitting LED lens according to claim 1, wherein the side surface is formed to emit light that is emitted from the end point of the light emitting surface of the LED chip, positioned at the same side as an arbitrary point on the side surface based on the optical axis of the LED chip, and incident on the arbitrary point on the side surface, out of the lens.

4. The side-emitting LED lens according to claim 3, wherein the side surface is formed to satisfy the following condition,
ΔR′/(R′Δα′) [symbol] 1/√(n²−1) condition:
α′=α+β−β′=α+β−sin⁻¹((1/n)×sin β)
(Here, α: angle between a horizontal axis perpendicular to the optical axis and light that is emitted from the end point of the light emitting surface of the LED chip and reaches an arbitrary point on the incident surface, β: angle between a normal at the arbitrary point on the incident surface and light that is emitted from the end point of the light emitting surface of the LED chip and reaches the arbitrary point on the incident surface, α′: angle between a horizontal axis perpendicular to the optical axis and light obtained via a process in which light reaching the arbitrary point on the incident surface is refracted and reaches an arbitrary point on the side surface, Δα′: increment in α′, R: distance between the arbitrary point on the side surface and the arbitrary point on the incident surface, ΔR′: increment in R′ with respect to Δα′, and n: refractive index of a material for forming the lens)

5. A side-emitting light emitting diode (LED) lens for emitting light emitted from an LED chip for emitting light as a volume source towards a side surface, comprising:
a lower surface comprising an incident surface with light emitted from the LED chip thereon;
an upper surface formed to total-reflect directly incident light among light beams incident on the incident surface; and
a side surface for connecting the lower surface and the upper surface and formed to emit directly incident light among light total-reflected by the upper surface and light incident on the incident surface, out of the lens,
wherein the upper surface is formed to total-reflect light that is emitted from a lower end point of the side surface of the LED chip, positioned at the same side as an arbitrary point on the upper surface based on an optical axis of the LED chip, and incident on the arbitrary point on the upper surface, towards the side surface.

6. The side-emitting LED lens according to claim 5, wherein the upper surface is formed to satisfy the following condition,
ΔR′/(R′Δα′) [symbol] 1/√(n²−1) condition:
α′=α+β−β′=α+β−sin⁻¹((1/n)×sin β)
(Here, α: angle between the optical axis and light that is emitted from a lower end point of the side surface of the LED chip and reaches an arbitrary point on the incident surface, β: angle between a normal at the arbitrary point on the incident surface and light that is emitted from the lower end point of the side surface of the LED chip and reaches the arbitrary point on the incident surface, α′: angle between the optical axis and light obtained via a process in which light reaching the arbitrary point on the incident surface is refracted and reaches the arbitrary point on the upper surface, Δα′: increment in α′, R: distance between the arbitrary point on the upper surface and the arbitrary point on the incident surface, ΔR′: increment in R′ with respect to Aα′, and n: refractive index of a material for forming the lens).

7. The side-emitting LED lens according to claim 5, wherein the side surface is formed to emit light that is emitted from the lower end point of the side surface of the LED chip, positioned at the same side as an arbitrary point on the side surface based on the optical axis of the LED chip, and incident on the arbitrary point on the side surface, out of the lens.

8. The side-emitting LED lens according to claim 7, wherein the side surface is formed to satisfy the following condition,
ΔR′/(R′Δα′) [symbol] 1/√(n²−1) condition:
α′=α+β−β′=α+β−sin⁻¹((1/n)×sin β)
(Here, α: angle between a horizontal axis perpendicular to the optical axis and light that is emitted from the lower end point of the side surface of the LED chip and reaches an arbitrary point on the incident surface, β: angle between a normal at the arbitrary point on the incident surface and light that is emitted from the lower end point of the side surface of the LED chip and reaches the arbitrary point on the incident surface, α′: angle between a horizontal axis perpendicular to the optical axis and light obtained via a process in which light reaching the arbitrary point on the incident surface is refracted and reaches an arbitrary point on the side surface, Δα′: increment in α′, R: distance between the arbitrary point on the side surface and the arbitrary point on the incident surface, ΔR′: increment in R′ with respect to Δα′, and n: refractive index of a material for forming the lens).

9. The side-emitting LED lens according to claim 1, wherein the side surface is increasingly inclined upwards based on the optical axis or increasingly inclined downwards based on the optical axis.

10. The side-emitting LED lens according to claim 1, further comprising a leg extending downwards from a predetermined position of the lower surface and supporting the lens.

11. A back light unit (BLU) using a light emitting diode (LED) chip as a light source, comprising the LED lens according to claim 1 on the LED chip.

12. A display device using a light emitting diode (LED) chip as a light source, comprising the LED lens according to claim 1 on the LED chip.

13. The side-emitting LED lens according to claim 5, wherein the side surface is increasingly inclined upwards based on the optical axis or increasingly inclined downwards based on the optical axis.

14. The side-emitting LED lens according to claim 5, further comprising a leg extending downwards from a predetermined position of the lower surface and supporting the lens.

15. A back light unit (BLU) using a light emitting diode (LED) chip as a light source, comprising the LED lens according to claim 5 on the LED chip.

16. A display device using a light emitting diode (LED) chip as a light source, comprising the LED lens according to claim 5 on the LED chip.
